(19) United States
(12) Patent Application Publication
(10) Pub. No.: US 2008/0240152 A1
(43) Pub. Date: Oct. 2, 2008

(54) System And Method For Communicating Data For Display On A Remote Display Device

(75) Inventors: Liam B. Quinn, Austin, TX (US); Samuel N. D'Alessio, Round Rock, TX (US); Bruce Montag, Austin, TX (US); Robert Winter, Leander, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/691,887

(22) Filed: Mar. 27, 2007

(51) Int. Cl. H04L 12/56

(52) U.S. Cl. 370/466; 370/389

(57) ABSTRACT

A system and method for communicating data for display on a remote display device are disclosed. A method includes converting at least one first DisplayPort transfer unit into at least one a network packet capable of being transmitted via a data network. The network packet may be transmitted via the data network and converted into at least one second DisplayPort transfer unit. The at least one second DisplayPort transfer unit may then be routed to a display device for display.

### TECHNICAL FIELD

The present disclosure relates in general to the display of images, and more particularly to a system and method for communicating data for display on a remote display device.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Today, networks are typically used to connect information handling systems, such as personal computers, workstations and servers, with network devices such as network attached storage devices, file servers, print servers, modems, hubs, display devices and other devices, including but not limited to other information handling systems. Examples of such networks include local area networks (LANs), metropolitan area networks (MANs), and wide area networks (WANs). These networks enable information handling systems to share information and resources. The information handling systems and network devices are often coupled to a switch fabric including one or more switching devices in order to facilitate communication among the devices. Generally speaking, devices coupled to the fabric may be capable of communicating with all other devices coupled to the fabric.

In some applications, networks are used to couple information handling systems to remote display devices in order to communicate data or information to the remote display devices. In such applications, remote display devices may be used to display airport arrival and departure schedules, subway, train or bus station schedules, advertising, moving images (e.g., at a sports stadium, sports arena and/or other public area), financial trading floor information, call center statistics, other digital signage, and/or other types of data, images or information.

Using conventional approaches to communicate data for remote display devices, an image rendering device (e.g., a graphics adapter in an information handling system) and one or more remote display devices are often interconnected via analog RGB video systems using analog modulation and amplifiers to redistribute video content to the remote display devices. This method typically results in poor signal quality, causing ghosting, smearing or jittering of video images on the remote display device screens. Such signal quality problems are of particular concern as the distance between a remote display device and the rendering device transmitting image data to the remote display device increases. Thus, conventional techniques limit the distance a remote device may be located from an information handling system or other image rendering device.

In addition, under conventional approaches, controlling a remote display device (e.g., powering the display “on” or “off”) and monitoring the status of a remote display device is often accomplished via proprietary control systems electrically wired from an information handling system to the remote display device. Such proprietary control systems are generally wired separately from the analog video systems described in the previous paragraph. Thus, individual installations of remote devices often require highly customized layout architectures with little flexibility for device location changes.

### SUMMARY

In accordance with the teachings of the present disclosure, various disadvantages and problems associated with communicating data to a remote display device have been substantially reduced or eliminated. In a particular embodiment, display data may be converted into a network packet and transmitted via a data network.

In accordance with one embodiment of the present disclosure, a method for communicating data for display on a remote display device is provided. The method may include converting at least one first DisplayPort transfer unit into a network packet capable of being transmitted via a data network. The DisplayPort transfer unit may include uncompressed display data. The network packet may be transmitted via the data network and converted into at least one second DisplayPort transfer unit.

In accordance with another embodiment of the present disclosure, a system for communicating data for display on a remote display device may comprise a data network, a first converter and a second converter. The first converter may be communicatively coupled to the data network and may be operable to convert at least one first DisplayPort transfer unit into a network packet capable of being transmitted via the data network. The Display Port transfer unit may include uncompressed display data. The second converter may be communicatively coupled to the data network and may be operable to convert the network packet into at least one second DisplayPort transfer unit.

In accordance with yet another embodiment of the present disclosure, a system for the display of images may comprise a host device, a data network, a first converter, a second converter, and a display device. The host device may be operable to transmit a first set of uncompressed display data representing an image to be displayed. The first converter may be communicatively coupled to the host and the data network, and may be operable to convert the display data into one or more network packets capable of being transmitted via the data network. The second converter may be communicatively coupled to the data network, and may be operable to convert the one or more network packets into a second set of uncompressed display data. The display device may be communicatively coupled to the second converter, and may be operable to display the image.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for display of images in accordance with teachings of the present disclosure;

FIG. 2 illustrates a diagram of a method for converting display data into network packets in accordance with certain embodiments of the present disclosure;

FIG. 3 illustrates an Ethernet packet encapsulating display data in accordance with certain embodiments of the present disclosure;

FIG. 4 illustrates a diagram of a method for converting network packets into display data in accordance with certain embodiments of the present disclosure; and

FIG. 5 illustrates a flow chart for an example method for communicating data for display on a remote display device in accordance with teachings of the present disclosure.

### DETAILED DESCRIPTION

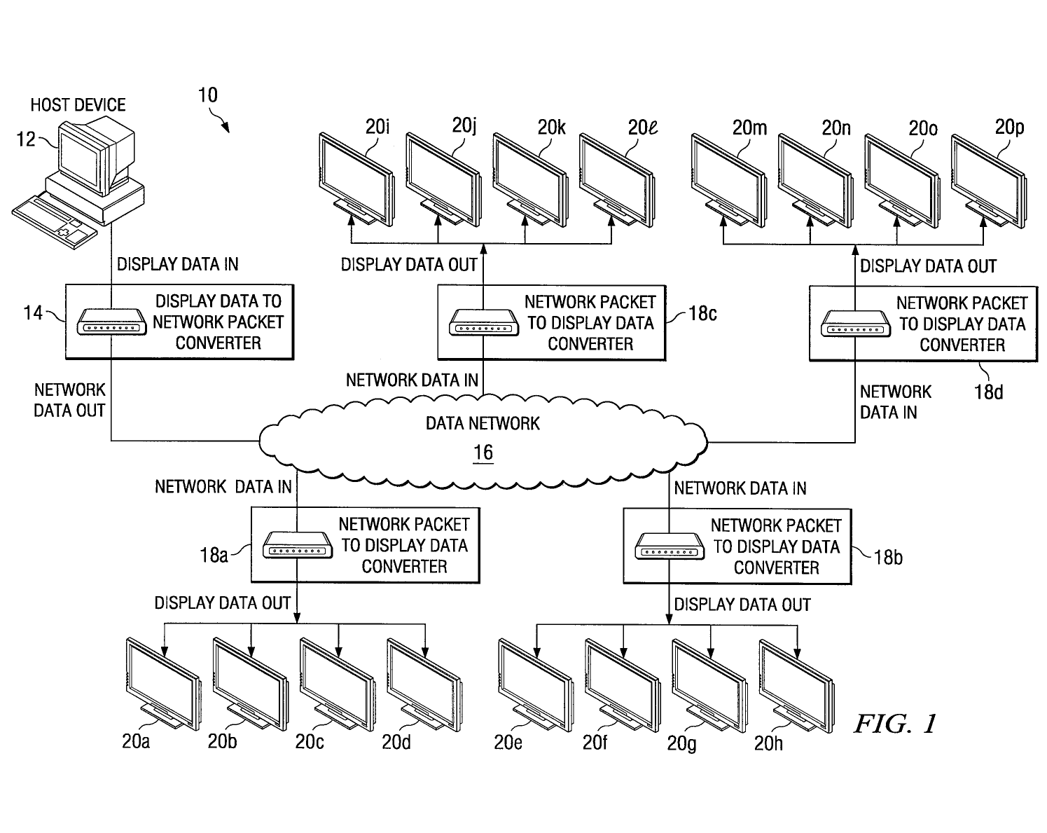

Preferred embodiments and their advantages are best understood by reference to FIGS. 1 through 5, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network storage device, or any other suitable device and may vary in size, shape, performance, functionality, and price. The information handling system may include memory, one or more processing resources such as a central processing unit (CPU) or hardware or software control logic. Additional components or the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

FIG. 1 illustrates a block diagram of an example system 10 for display of images in accordance with teachings of the present disclosure. As shown in FIG. 1, system 10 may comprise host device 12, display data to network packet converter 14, data network 16, network packet to display data converters 18a, 18b, 18c and 18d (generally referred to as converters 18) and display devices 20a-20p (referred to generally as display devices 20).

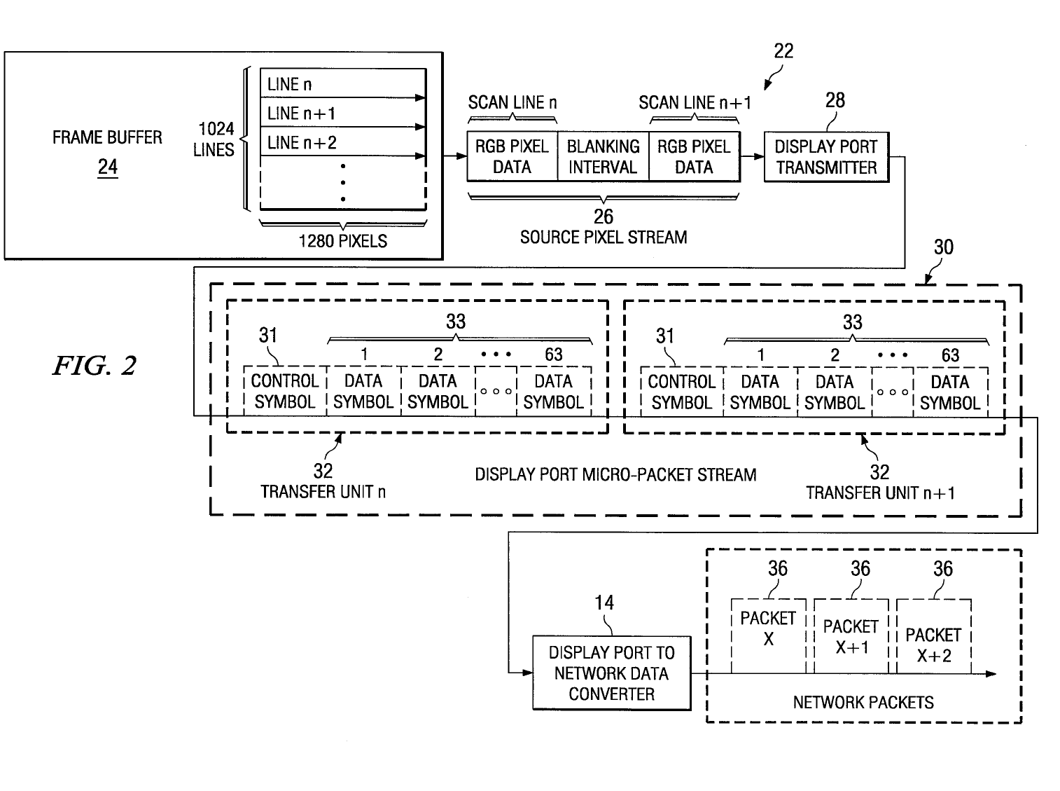

Host device 12 may generally include any system or apparatus operable to process, store, render and/or transmit display data in accordance with the teachings of this disclosure. Host device 12 may include one or more information handling systems, as defined herein. In some embodiments, host device 12 may comprise a digital media server operable to store and/or transmit digital media from a digital source (e.g. host device 12) to a video and/or audio device (e.g. display devices 20). In the same or alternative embodiments, host device 12 may comprise a DisplayPort transmitter (as depicted in FIG. 2) operable to transmit display data using the DisplayPort digital display interface standard. As used in this disclosure, “DisplayPort data” shall mean data formatted in accordance with DisplayPort Specification version 1.0 and any and all revisions thereto. Although only one host device 12 is depicted in FIG. 1, it is understood that system 10 may include any number of host devices 12.

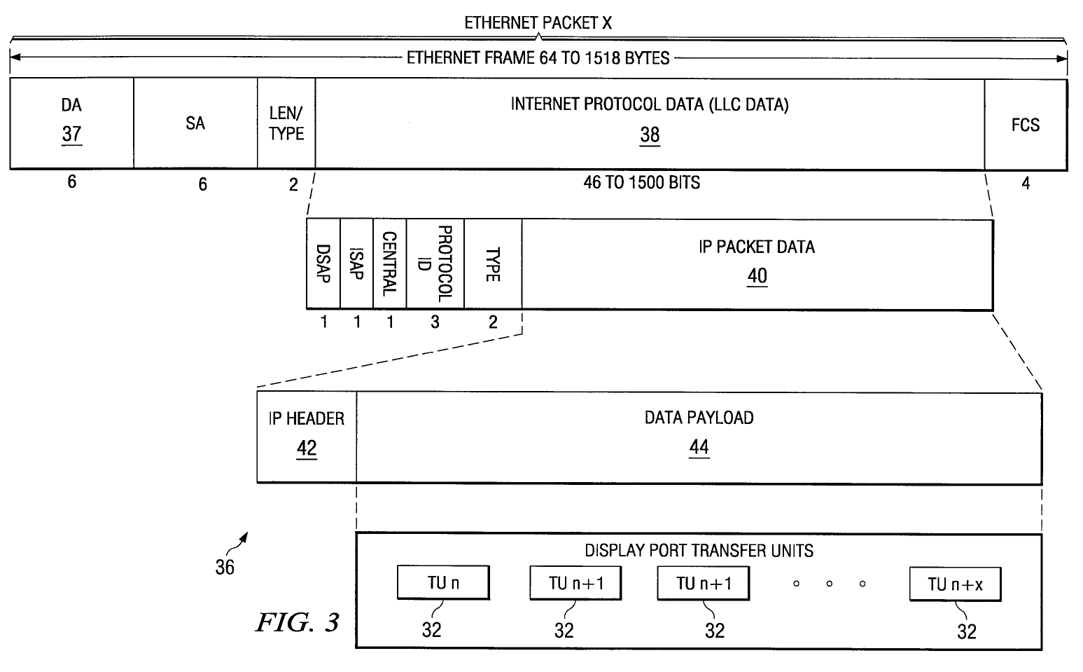

Converter 14 may generally include any system or apparatus operable to convert and/or translate display data transmitted from host device 12 into network data capable of being transmitted over data network 16. In certain embodiments, display data converted, translated and/or routed by converter 14 may be uncompressed display data. Each of converters 14 may also be able to route display data to one or more converters 18. In certain embodiments, converter may be operable to convert DisplayPort data into network data as further depicted in FIGS. 2 and 3. In the same or alternative embodiments, the network data may include one or more Ethernet packets. Although only one converter 14 is depicted in FIG. 1, it is understood that system 10 may include any number of converters 14.

Data network 16 may be a local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). In a particular embodiment, data network 16 may transmit media using Transmission Control Protocol (TCP) and/or Internet Protocol (IP) standards over an Ethernet network. In the same or alternative embodiments data network 16 may transmit media using the IEEE 802.3ae and/or 802.3av 10 gigabit Ethernet (10 GbE) standard. Although subsequent description will primarily focus on Ethernet and TCP/IP standards and protocols, it should be understood that other appropriate methods of transmitting media over a network, such as a Frame Relay, Asynchronous Transfer Mode (ATM), Fibre Channel (FC), other packet-based protocol, or other transmission protocols and standards are also included within the scope of the present disclosure.

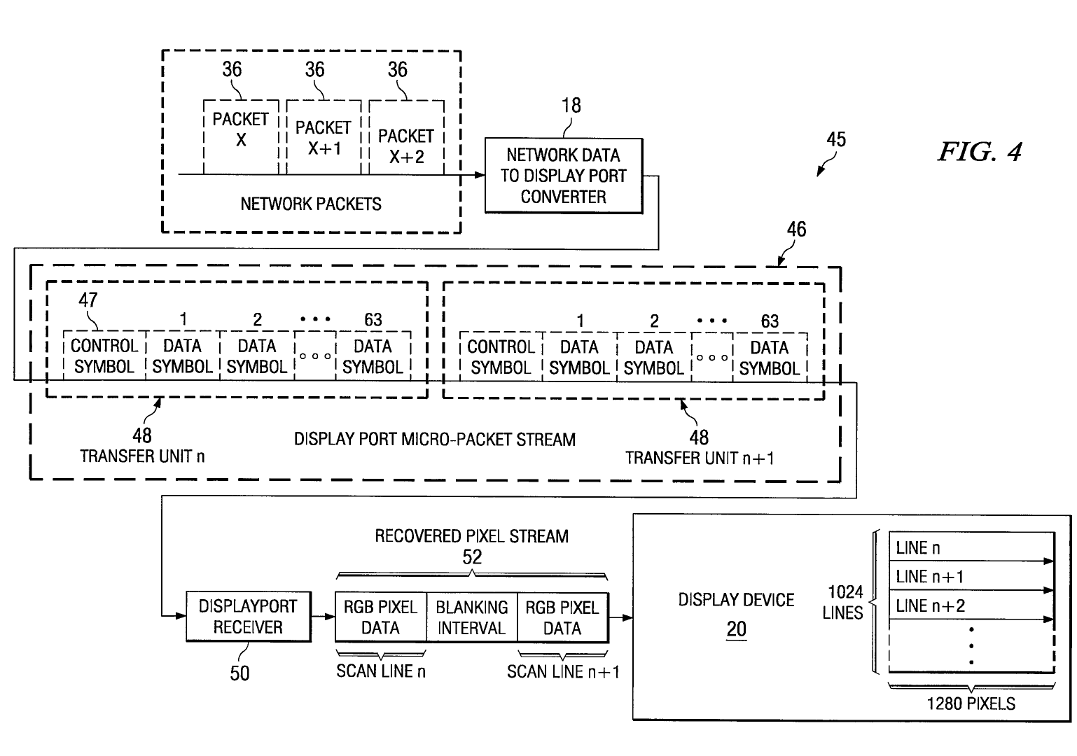

Each of converters 18 may generally include any system or apparatus operable to convert and/or translate network data transmitted over network 16 into display data capable of being displayed on a display device 20 and/or operable to control controlling display device 20. Each of converters 18 may also be operable to route display data to one or more display devices 20. In certain embodiments, each of converters 18 may be operable to convert network data into DisplayPort data as further depicted in FIG. 4. In the same or alternative embodiments, the network data may include one or more Ethernet data packets. Although a specific number of converters 18 are depicted in FIG. 1, it is understood that system 10 may include any number of converters 18.

Each of display devices 20 may generally include any system or apparatus operable to display one or more images corresponding to display data transmitted by one or more of converters 18. Each of display devices 20 may be operable to process display data and display images according to any image and/or video standard, protocol, format, and/or resolution, including without limitation video graphics array (VGA), super video graphics array (SVGA), extended graphics array (XGA), wide extended graphics array (WXGA), super extended graphics array (SXGA), super extended graphics array plus (SXGA+), wide super extended graphics array plus (WSXGA+), ultra extended graphics array (UXGA), wide ultra extended graphics array (WUXGA), quad extended graphics array (QXGA), wide quad graphics extended array (WQXGA), 720p, 1080i, and 1080p. In certain embodiments, each of display devices 20 may include a DisplayPort receiver (as further detailed in FIG. 4) operable to receive and/or process DisplayPort data. Although a certain number of display devices 20 are depicted in FIG. 1, it is understood that system 10 may include any number of display devices.

In operation, host device 12 may transmit a first set of display data (e.g. DisplayPort data) to converter 14. In some embodiments the first set of display data may include uncompressed digital data. In the same or alternative embodiments, the first set of display data may include uncompressed DisplayPort data. In certain embodiments, the first set of display data may correspond to one or more images to be displayed on a display device 20. In the same or alternative embodiments, the first set of display data may include control data for controlling a display device 20 (e.g., turning the display device “on” or “off,” or adjusting the brightness contrast, tint or color of the display device). Converter 14 may convert the first set of display data into one or more network packets capable of being transmitted over data network 16. In some embodiments, the one or more network packets may be Ethernet packets. Converter 14 may additionally route the network packets to one or more converters 18 based on an address included in each of network packets. Converter 18 may convert any or all of the network packets into a second set of data capable of being displayed on one or more of display devices 20 and/or capable of controlling one or more of display devices 20. In some embodiments, the second set of data may be substantially similar to the first set of data. In some embodiments, converters 18 may convert the network packets into DisplayPort data. After conversion of data by converter 18, converter 18 may route the second set of display data to one or more display devices 20 for display and/or control.

System 10 depicted in FIG. 1 may overcome many disadvantages of conventional approaches of communicating display data to remote display devices. For example, because system 10 allows remote transmission of display data in digital form, signal quality issues associated with analog transmission of image data may be overcome. Furthermore, signals for controlling remote devices may also be transmitted digitally in system 10, thus possibly obviating the need for proprietary control systems requiring customized layout. Moreover, those embodiments of system 10 that permit communication of uncompressed display data may allow improved image quality at display devices 20, as signal degradation associated with conventional display data decompression techniques may be avoided.

FIG. 2 illustrates a diagram of a method for converting display data into network packets in accordance with certain embodiments of the present disclosure. As depicted in FIG. 2, frame buffer 24 corresponding to an image, may be translated by host device 12 (or another suitable system or apparatus) into display data, e.g. source pixel stream 26. Source pixel stream 26 may comprise RGB data or other suitable image data format. DisplayPort transmitter 28 may convert source pixel stream 26 into an uncompressed DisplayPort micro-packet stream 30 in accordance with the DisplayPort Specification. In some embodiments, DisplayPort transmitter 28 may be an integral part of host device 12.

Micro-packet stream 30 may include one or more DisplayPort transfer units 32. Pursuant to the DisplayPort Specification, a transfer unit is a data structure used to carry pixel stream data in compressed form in a DisplayPort compliant medium. Each transfer unit 32 may comprise control signal 31 and data symbols 33. In certain embodiments, each control symbol and each data symbol may be eight (8) or ten (10) bits in length, in accordance with the DisplayPort Specification. In the same or alternative embodiments, transfer units 32 may comprise sixty-three (63) data symbols, in accordance with the DisplayPort specification. In the same or alternative embodiments, control symbol 31 of transfer units 32 may include data representing an address corresponding to one or more display devices 20, in order to ensure proper delivery of display data to the correct display devices 20.

Converter 14, depicted in FIG. 2 as a DisplayPort to network data converter, may convert and/or translate transfer units 32 into network packets 36. In certain embodiments, converter 14 may convert and/or translate transfer units 32 into one or more Ethernet packets including, without limitation, packets compliant with the 10 GbE standard. In the same or alternative embodiments, network packets 36 may comprise Ethernet packets, and converter 14 may encapsulate the one or more transfer units 32 within one or more Ethernet packets without altering or compressing the transfer units 32, as depicted in greater detail in FIG. 3.

Although FIG. 2 depicts the conversion of source pixel stream 26 into DisplayPort micro-packet stream 30, it is understood that in certain embodiments source pixel stream 26 may be converted into a display data standard other than the DisplayPort standard prior to conversion into network packets 36. In the same or alternative embodiments, source pixel stream 26 may be directly converted into network packets 36. It is also understood that in some embodiments display data formats other than pixel streams and DisplayPort data may be converted into network packets 36. Further, although FIG. 2 depicts an image resolution of 1024 by 1280 pixels, it is understood that images of all resolutions may be communicated to display devices 20 in accordance with this disclosure.

FIG. 3 illustrates network packet 36 encapsulating display data in accordance with certain embodiments of the present disclosure. Although FIG. 3 depicts that network packet 36 is an Ethernet packet, it is understood that other appropriate methods of transmitting data over a network, such as a Frame Relay, Asynchronous Transfer Mode (ATM), Fibre Channel (FC), other packet-based protocol, or other transmission protocols and standards are also included within the scope of the present disclosure.

Network packet 36 may include a destination address (DA) field 37 and an IP data field 38. DA field 37 may include an address representing a destination address of network packet in 37. DA field 37 may include an address identifying one or more converters 18 and/or display devices 20 as the destination(s) of network packet 36. In particular embodiments, DA field 37 may be six (6) bytes.

In accordance with the Ethernet standard, data field 38 may comprise between 45 to 1500 bytes, inclusive. Data field 38 may comprise IP packet data field 40, which may include IP header field 42 and data payload field 44. IP header field 42 may include an address identifying one or more converters 18 and/or display devices 20 as the destination(s) of network packet 36. Data payload field may comprise display data, for example one or more DisplayPort transfer units 32.

In operation, converter 14 may encapsulate transfer units 32 within the data payload fields 44 of one or more Ethernet packets 36 without altering and/or compressing the content of transfer units 32. The transmission of uncompressed transfer units 32 may avoid the need for image data decompression and the decrease in image quality often associated with decompression techniques. In addition, during the conversion converter 14 may extract address data from the control symbols 31 of transfer units 32, and, based at least on the extracted address, write an address to DA field 37 or IP header 42 corresponding to one or more destination converters 18 and/or one or more display devices 20 for the display data.

FIG. 4 illustrates a diagram of the conversion of network packets to display data in accordance with certain embodiments of the present disclosure. Converter 18, depicted in FIG. 4 as a network data to DisplayPort converter, may convert and/or translate one or more network packets 36 into one or more DisplayPort transfer units 48. In certain embodiments, converter 18 may convert and/or translate one or more Ethernet packets into DisplayPort micro-packet stream 46, comprising one or more transfer units 48. In the same or alternative embodiments, transfer units 48 may be encapsulated within network packets 36 (as depicted in FIG. 3), and converter 18 may extract encapsulated transfer units 48 from network packets 48. In the same or alternative embodiments, transfer units 48 may be substantially similar to transfer units 32 depicted in FIGS. 2 and 3.

Converter 18 may also route one or more of transfer units 48 to a particular display device 20 for display on and/or control of such display device 20. Converter 18 may route transfer units 48 based at least on address data in a DA field 37 or IP header 42 of a network packet 36 and/or a control symbol 47 of one or more of transfer units 48.

DisplayPort receiver 50 may convert micro-packet stream 46 into a recovered pixel stream 52 corresponding to an image to be displayed in accordance with the DisplayPort standard. In some embodiments, DisplayPort receiver 50 may be integral to display device 20. After micro-packet stream 46 has been converted into recovered pixel stream 52, an image corresponding to recovered pixel stream 52 may be displayed on display device 20.

Although FIG. 4 depicts the conversion of source DisplayPort micro-packet stream 46 into recovered pixel stream 52, it is understood that in certain embodiments a display data standard other than the DisplayPort standard (including other uncompressed data formats) may be converted into recovered pixel stream 52. In the same or alternative embodiments, network packets 36 may be directly converted into recovered pixel stream 52. It is also understood that in some embodiments image data formats other than pixel streams and DisplayPort data may be created from the conversion of network packets 36 and displayed on display devices 20. Further, although FIG. 4 depicts an image resolution of 1024 by 1280 pixels, it is understood that images of all resolutions may be communicated to display devices 20 in accordance with this disclosure.

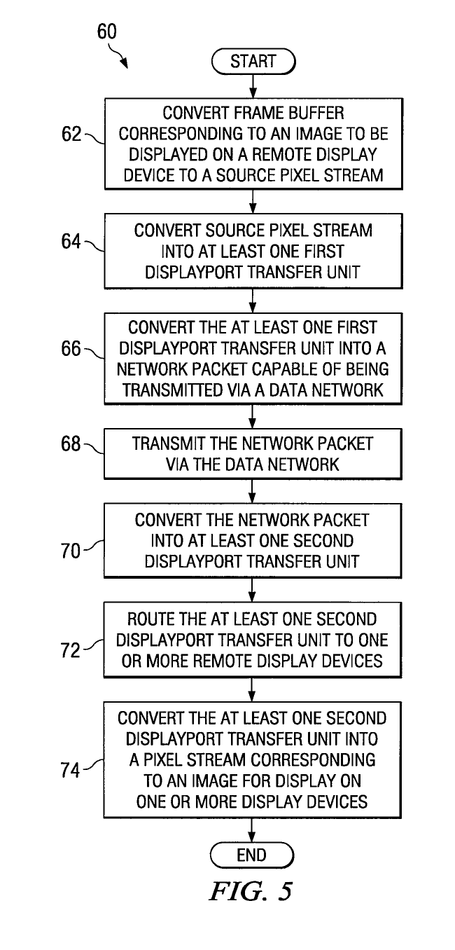

FIG. 5 illustrates a flow chart for an example method for communicating data for display on a remote display device. In the embodiments disclosed herein, method 60 may utilize a transmission standard, such as TCP/IP over Ethernet, by using system 10, host device 12, converter 14, data network 16, converters 18 and display devices 20 as illustrated in FIG. 1 that support TCP/IP and Ethernet standards. Nonetheless, it should be understood that method 60 may, within the scope of the present disclosure, be implemented using other appropriate methods of transmitting media over a network, such as a Frame Relay, Asynchronous Transfer Mode (ATM), Fibre Channel (FC), other packet-based protocols, or other transmission protocols and standards. In addition, in the embodiments disclosed herein, method 60 may utilize a display standard, such as the DisplayPort standard, by using system 10, host device 12, converter 14, data network 16, converters 18 and display devices 20 that support the DisplayPort standard. Nonetheless, it should be understood that method 60 may, within the scope of the present disclosure, be implemented using any other appropriate digital display interface standards and formats.

In one embodiment, method 60 includes a first set of display data transmitted from host device 12 to converter 14, where the first set of display data is converted into a network packet and transmitted over network 16. In some embodiments the first set of display data is not compressed and/or altered when converted into a network packet. The network packet is received at one or more converters 18, where the packet is converted into a second set of display data which is routed to one or more display devices 20.

According to one embodiment, method 60 preferably begins at step 62. As mentioned above, teachings of the present disclosure may be implemented in a variety of configurations of system 10. As such, the preferred initialization point for method 60 and the order of the steps 62-74 comprising method 60 may depend on the implementation chosen.

At step 62, a host device (or other suitable system or apparatus), such as host device 12, may convert a frame buffer corresponding to an image to be displayed on a remote display device, such as frame buffer 24, to a pixel stream, such as source pixel stream 26. At step 64, a transmitter, such as DisplayPort transmitter 28, may convert source pixel stream 26 into at least one first DisplayPort transfer unit 32. Transmitter 28 may also transmit the at least one first transfer unit 32 to converter 14.

At step 66, converter 14 may convert the at least one first DisplayPort transfer unit 32 into a network packet 36 capable of being transmitted via data network 16. At step 68, converter 14 or another suitable component of system 10 may transmit network packet 36 via data network 16. In some embodiments, converter 14 may be an integral part of a router and/or information handling system.

At step 70, converter 18 (which may be an integral part of a router and/or information handling system) may convert network packet 36 into at least one second DisplayPort transfer unit 48, as depicted in FIG. 4. In certain embodiments, the at least one second transfer unit 48 may be substantially similar to the at least one first transfer unit 32. At step 72, converter 18 may route the at least one second DisplayPort transfer unit 48 to one or more display devices 20. At step 74, a receiver, such as DisplayPort receiver 50 may convert the at least one second transfer unit into a pixel stream, such as source pixel stream 52, for display on one or more remote display devices 20. After completion of step 72, method 60 may end.

It should be understood that various changes, substitutions and alternations can be made herein without departing from the spirit and scope of the disclosure as illustrated by the following claims.

What is claimed is:

1. A method for communicating data for display on a remote display device comprising:
converting at least one first DisplayPort transfer unit into a network packet capable of being transmitted via a data network, the DisplayPort transfer unit including uncompressed display data;
transmitting the network packet via the data network; and
converting the network packet into at least one second DisplayPort transfer unit.

2. The method of claim 1, wherein the at least one first DisplayPort transfer unit is substantially similar to the at least one second DisplayPort transfer unit.

3. The method of claim 1, wherein converting the at least one first DisplayPort transfer unit into the network packet comprises encapsulating the at least one first transfer unit within the network packet without altering or compressing the at least one first transfer unit.

4. The method of claim 3, wherein converting the network packet into the at least one second transfer unit comprises extracting the at least one first transfer unit without altering or compressing the first transfer unit.

5. The method of claim 1, wherein:
the network packet comprises an Internet Protocol (IP) packet; and
the data network comprises an IP network.

6. The method of claim 1, further comprising converting a pixel stream into the at least one first DisplayPort transfer unit, the pixel stream corresponding to an image to be displayed on a remote display device.

7. The method of claim 1, further comprising converting the at least one second DisplayPort transfer unit into a pixel stream corresponding to an image for display on one or more remote display devices.

8. The method of claim 1, wherein at least one of the transfer units of each of the first set of transfer units and second set of transfer units comprises data representing an address corresponding to one or more remote display devices.

9. A system for communicating data for display on a remote display device comprising:
a data network;
a first converter communicatively coupled to the data network, the first converter operable to convert at least one first DisplayPort transfer unit into a network packet capable of being transmitted via the data network, the DisplayPort transfer unit including uncompressed display data; and
a second converter communicatively coupled to the data network, the second converter operable to convert the network packet into at least one second DisplayPort transfer unit.

10. The system of claim 9, wherein the at least one first DisplayPort transfer unit is substantially similar to the at least one second DisplayPort transfer unit.

11. The system of claim 9, the first converter further operable to encapsulate the at least one first transfer unit within the network packet without altering or compressing the at least one first transfer unit.

12. The system of claim 11, the second converter further operable to convert the network packet into the at least one second DisplayPort transfer unit by extracting the at least one first transfer unit from the network packet.

13. The system of claim 9, wherein:
the network packet comprises an Internet Protocol (IP) packet; and
the data network comprises an IP network.

14. The system of claim 9, further comprising a transmitter operable to convert a pixel stream into the first set of DisplayPort transfer units, the pixel stream corresponding to an image to be displayed on a remote display device.

15. The system of claim 9, further comprising a receiver operable to convert the second set of DisplayPort transfer units into a pixel stream corresponding to an image for display on one or more remote display devices.

16. The system of claim 9, wherein at least one of the transfer units of each of the first set of transfer units and second set of transfer units comprises data representing an address corresponding to one or more remote display devices.

17. A system for the display of images comprising:
a host device operable to transmit a first set of uncompressed display data representing an image to be displayed;
a data network;
a first converter communicatively coupled to the host and the data network, the first converter operable to convert the first set of display data into one or more network packets capable of being transmitted via the data network;
a second converter communicatively coupled to the data network, the second converter operable to convert the one or more network packets into a second set of uncompressed display data; and
a display device communicatively coupled to the second converter, the display device operable to display the image.

18. The system of claim 17, wherein:
at least one of the first set of display data and the second set of display data comprises control data for the display device; and
the display device is further operable to respond to the control data.

19. The system of claim 17, wherein the first set of display data comprises one or more DisplayPort transfer units and the host further comprises a transmitter operable to convert a pixel stream into the first set of image data, the pixel stream corresponding to the image.

20. The system of claim 17, wherein the second set of display data comprises one or more DisplayPort transfer units and the display device further comprises a receiver operable to convert the second set of display data into a pixel stream corresponding to an image for display on the display device.
